(19) United States
(12) Patent Application Publication
(10) Pub. No.: US 2003/0140607 A1
(43) Pub. Date: Jul. 31, 2003

(54) Air tank and method and apparatus for filling

(76) Inventor: George Benda, Maunaloa, HI (US)

Correspondence Address: Clifford Kraft, 320 Robin Hill Dr., Naperville, IL, 60540, US

(21) Appl. No.: 10/331,173

(22) Filed: Dec. 27, 2002

Related U.S. Application Data
(60) Provisional application No. 60/346,088, filed on Jan. 3, 2002.

(51) Int. Cl. B01D 50/00

(52) U.S. Cl. 55/385.1; 55/385.4; 222/3; 220/581

(57) ABSTRACT

A low pressure tank and filler mechanism for holding clean air for dispensing in the vicinity of a user. The tank can contain a plurality of balloon-like structures, each holding a certain quantity of low pressure air. The balloons are coupled to a central hollow column or manifold whereby pure air is either loaded or discharged from the balloons. The tank mates by an external valve into a filler machanism that conveniently fills the tank with air that has been purified by passing it through a series of different types of filters.

This application claims priority from U.S. Provisional patent application No. 60/346,088 filed Jan. 3, 2002 and hereby incorporates that application by reference.

### BACKGROUND

1. Field of the Invention

The present invention relates to the general field of indoor air quality and more particularly to a tank and tank filler apparatus the contains treated fresh air.

2. State of the Art

Indoor air quality has become a major concern for health and comfort both in homes and in commercial settings. Since clean air is not always available, a system has been devised that supplies a personal plume of clean air around the face of a user. Such a system requires a tank of clean air under some pressure so that the clean air can be dispensed.

What is badly needed is a method and apparatus of holding this pressurized air and a method and apparatus for filling the tanks. There should be alternatives to the tanks being high pressure vessels because of the difficulty and danger of handling high pressure tanks.

### SUMMARY OF THE INVENTION

The present invention relates to a new type of low pressure tank for holding pure air to be dispensed in a personal breathing space and to an apparatus and method for filling the tank.

A tank is required for supplying pure air for a personal air dispensing apparatus. This tank can be a pressure vessel capable of being pressurized to a certain pressure, or it can be a tank frame containing a plurality of balloon-like structures each loaded with freshened air separately and each dispensing its air at a constant flow rate.

Each balloon component can be attached to a central feed whereby the balloon feeds its air into a central column and out to an outlet valve. The pressure caused by the elastic force of each balloon as well as pressure caused by additional air loaded into the balloons against the side of the tank allows dispensing of the personal air.

An apparatus for filling tanks can comprise a series of filters and treatments for the air including a high efficiency particulate air filter (HEPA) to remove particulate matter, a carbon or equivalent filter to remove chemicals, and optionally, the addition of fragrance into the loaded air. The air can be loaded into the bottle by means of a low pressure pump.

### DESCRIPTION OF THE FIGURES

FIG. 1 shows a perspective view of an embodiment of the present invention that is a front and side view of a personal air bottle.

FIG. 2 shows a side and top section view of a bottle like that of FIG. 1.

FIG. 3 shows a view of an apparatus for loading air into bottles such as those shown in FIGS. 1 and 2.

It should be understood that the figures contained herein are to illustrate aspects of the present invention. It will be apparent to one skilled in the art that many other changes, variations, and embodiments are within the scope of the present invention.

### DESCRIPTION OF THE INVENTION

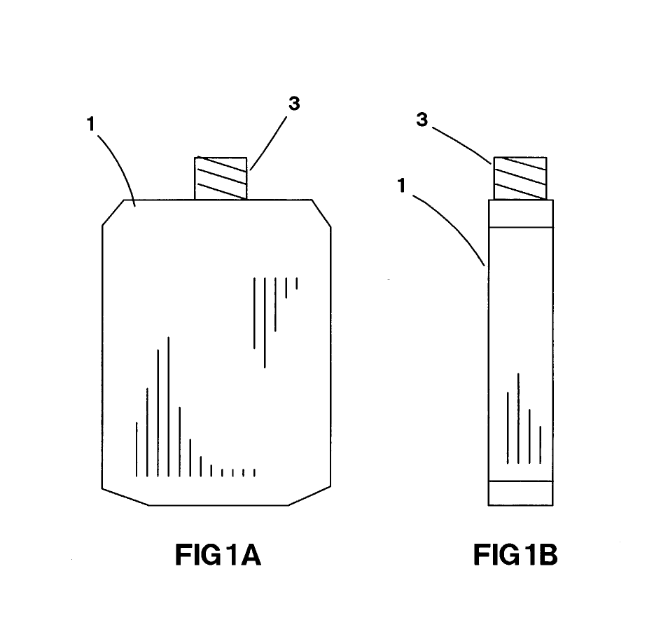

FIG. 1A shows a front and FIG. 1B a side view of an embodiment of a personal air bottle. The bottle contains an outer wall 1 of durable material. Metal can be used or plastic or any other durable material. On the top of the bottle is a screw on cap neck 3 that can mate with a control valve and possible regulator for personal air dispensing. It is possible for the bottle shown in FIGS. 1A-1B to be a pressure vessel; however, as will be explained, an embodiment of the present invention allows the bottle to be just a shell not required to contain much air pressure itself.

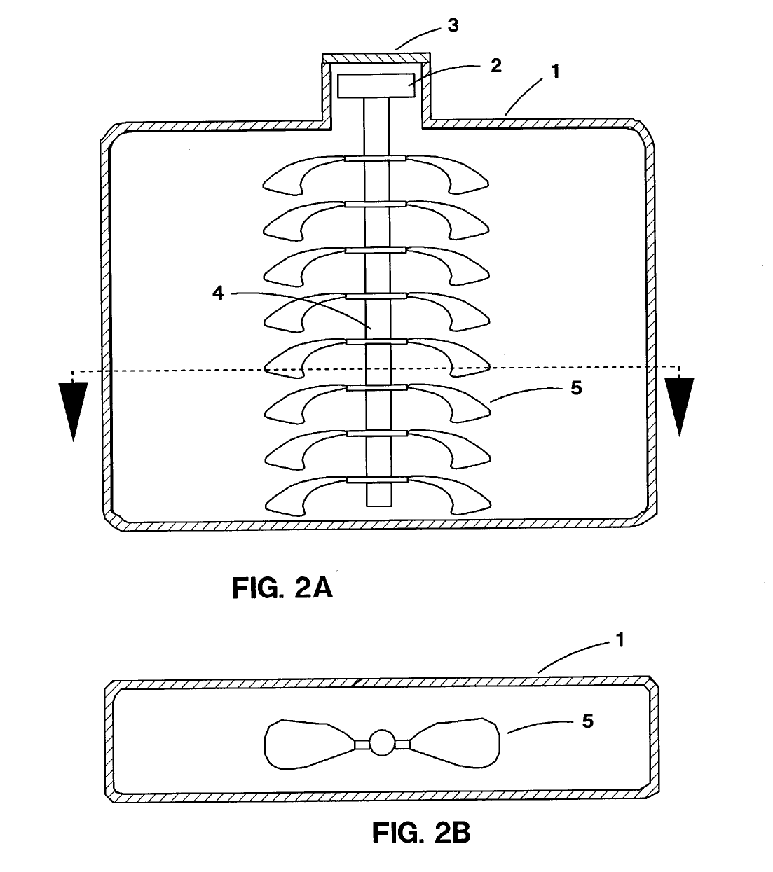

FIGS. 2A and 2B show respectively a side section and a top section of a bottle similar to that shown in FIGS. 1A-1B. Again, the outer durable shell 1 and neck 3 are seen. In addition there can be a needle valve 2 similar to that used with basketballs that can provide a means for filling and controlled release of the air. The bottle shell 1 can contain a plurality of balloon-like inflatable bladders 5 that can be inflated exactly like toy balloons. These balloon-like structures 5 can be attached to a central distribution and access tube or manifold 4 that allows blowing up and extracting air from the bladders 5.

When the apparatus is filled with air, the balloon-like bladders 5 expand until they fill the internal space of the bottle 1. More air can then be put into them if desired with increasing pressure on the bottle shell 1. The bladders 5 can be filled through the manifold 4 until all available space is used.

Air can be released at a regular rate from the bladders 5 first by any over-pressure that is present, and when the over-pressure is used up, from the elastic contraction of the bladder material. The bladders 5 can be made of rubber (real or synthetic), or of any other rubber like material that can hold air under moderate pressure without leaking. The material used to make balloons is preferred. The fact that the bladders 5 will contract elastically allows a continuous air flow without the outer bottle shell 1 having to be a pressure vessel.

It should be understood that the shape of the bottles of FIGS. 1A-1B and 2A-2B is for illustration only. Many other shapes of bottles are within the scope of the present invention.

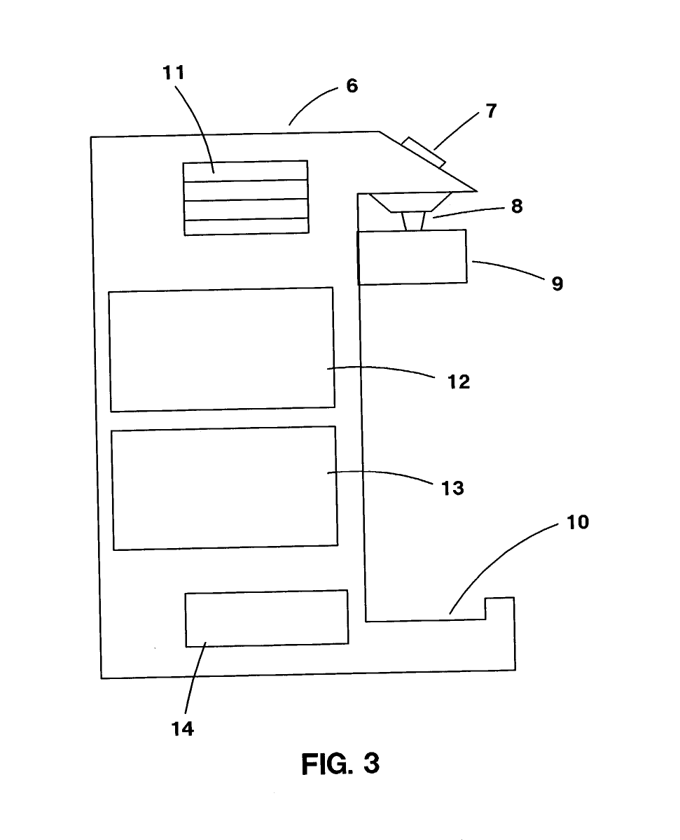

FIG. 3 shows an apparatus for filling and conditioning air to be loaded and dispensed by the bottles of FIGS. 1-2. A base 10 holds the bottle to be filled. An interface 9 mates with the actual bottle top or neck 3 (FIG. 1A) and allows a filler attachment 8 to pump air into the bottle. Ambient air enters the apparatus through a vent 11 and is passed through a series of stages before reaching the actual bottle.

The first stage is a high efficiency particulate air filter (HEPA) 12 or equivalent that removes almost all particulate matter from the ambient air. Especially removed is dust and biological material such as fungi, mold and some microbes. Also smoke particles are mostly removed in this filter 12.

Next an activated carbon filter 13 or equivalent removes chemical contaminants and odors from the filtered ambient air. This filter can also be treated to kill all bacteria and viruses as well as remove chemicals. An alternative is to pass the airflow through a high intensity ultraviolet lamp (not shown) with wavelength shorter than around 340 nanometers to kill biological material, especially microbes.

Finally, the air can optionally be passed through a stage that can be called an air augmentation module 14. Here a fine fragrance can be added to the air to produce a pleasant effect for the user. The user could optionally choose the fragrance to their liking (rose, lemon, or any other fragrance).

The filtered and augmented air can then be pumped up to the air injector 8 and injected into the bottle (of FIGS. 1-2). A control panel 7 can control the injection and allow choice of a fragrance if such is desired by the user.

It should be understood that the examples and embodiments herein described are for illustration only. A person skilled in the art will recognize that many variations are possible and many other embodiments are within the scope of the present invention.

I claim:

1. A tank and filler apparatus comprising in combination:
a low pressure tank containing a plurality of balloons in communication with a hollow central column, said hollow central column forming a gas passage from said balloons to an external valve mechanism, said balloons capable of holding a volume of gas at low pressure;
a filler mechanism mating to said external valve, said filler mechanism opening said valve when mated, said filler mechanism holding said tank conveniently for filling.

2. The tank and filler apparatus of claim 1 wherein said tank is metal.

3. The tank and filler apparatus of claim 1 wherein said balloons are rubber.

4. The tank and filler apparatus of claim 1 wherein said mating filler mechanism mates with said external valve by pressing a filler attachement into said exteral valve.

5. the tank and filler apparatus of claim 1 further comprising a pluality of air filters in said filler mechanism, said filters filtering ambient air for filling.
